(19) United States
(12) Patent Application Publication
(10) Pub. No.: US 2018/0339545 A1
(43) Pub. Date: Nov. 29, 2018

(54) Multi-Tool Jewelry

(71) Applicant: Caffeinate Labs, Inc., Bedford, MA (US)

(72) Inventor: Nathan Gregg Barr, Portland, ME (US)

(73) Assignee: Caffeinate Labs, Inc., Bedford, MA (US)

(21) Appl. No.: 15/604,645

(22) Filed: May 24, 2017

(51) Int. Cl. B44B 3/06; A44C 15/00

(52) U.S. Cl. CPC B44B 3/065; A44C 17/0208; A44C 15/005; A44C 15/003

(57) ABSTRACT

This invention is directed toward a piece of jewelry having one or more stackable tools. The stackable tools have the advantage of being able to be removed from the piece of jewelry, used by the wearer, and returned to the piece of jewelry without having to remove the piece of jewelry. Two of the key features of this invention, namely the stackability of the tools and the ability to remove and use the tools from the jewelry while still wearing the jewelry, are incredibly advantageous for the user. The stackability allows a user to customize the jewelry so that he or she always has the preferred assortment of tools handy when needed. The removability for use while still wearing the jewelry allows a user to avoid common mishaps, such as dropping the necklace when trying to take off a tool thereby losing one or all of the tools.

### FIELD

The present invention relates generally to pieces of jewelry that are at once decorative and simultaneously useful in that the jewelry is comprised of a multi-tool set.

### BACKGROUND

In the area of combining tools with jewelry, there appears to be two purposes for those combinations, ornamental and functional. On the ornamental side, there are various pieces of jewelry that attach pendants or charms made in the shape of popular tools. There are many such examples of this type of jewelry on the Internet. See e.g., https://www.etsy.com/listing/158265772/pipe-wrench-charm-necklace-charm?ref=related-3 Most of these pendants and charms are designed for purely ornamental purposes and would not, therefor, function as the tool they are designed to replicate.

On the functional side of tool jewelry, there are examples in the prior art of bracelets, necklaces and the like that can also include functional tools. As an example, the survival dog tags taught by U.S. Patent Publication No. 2015/0135768 can be used as fire starting tools. As a second example, U.S. Pat. No. 9,804,455 to Millan teaches a bracelet containing myriad survival tools including a knife, fishing line and hook, fire starting mechanism, and the like. The tools are encased within a rope or string and can be worn around an individual's wrist as a bracelet. In order to access the tools, the wearer must remove the bracelet and unwrap the rope or string before using the various survival tools contained within the Millan bracelet.

While the idea of combining tools with jewelry can be found in prior art teachings, these jewelry pieces have one consistent drawback, they must be removed in order for the wearer to make use of any of the tools provided as part of the piece of jewelry. Both the Millan bracelet and the survival dog tags must be removed from the wearer's wrist or neck before he or she can make use of any of the tools contained therein. Removing a necklace or bracelet in order to use the tools contained on or in the jewelry has several drawbacks. First, if it is cold out, it can be challenging to have the dexterity to open and close a necklace or bracelet clasp. This is especially true if the wearer has on gloves or mittens. Second, it is very easy when taking off a necklace or bracelet to drop the necklace or bracelet. This could result in the wearer completely losing the tool if for example he is on a boat and the necklace or bracelet falls overboard, or on a hiking trail and the necklace or bracelet falls over the edge of the mountain, in the dark and the necklace or bracelet falls on the ground, There are infinite situations where having to remove a necklace or bracelet from one's person is inconvenient at best and defeats the entire purpose of having a tool at worst.

There is therefore a need to provide consumers with jewelry that contains a tool or tool set that can be used without having to remove the jewelry from the wearer's neck, wrist, ankle, or the like.

### SUMMARY OF THE INVENTION

The invention disclosed herein overcomes some of the shortcomings of the prior art by disclosing a piece of jewelry having stackable tools located thereon. The stackable tools have the advantage of being able to be removed from the piece of jewelry, used by the wearer, and returned to the piece of jewelry without having to remove the piece of jewelry. Two of the key features of this invention, namely the stackability of the tools and the ability to remove and use the tools from the jewelry while still wearing the jewelry, are incredibly advantageous for the user. The stackability allows a user to customize the jewelry so that he or she always has the preferred assortment of tools handy when needed. The removability for use while still wearing the jewelry allows a user to avoid common mishaps, such as dropping the necklace when trying to take off a tool thereby losing one or all of the tools.

In some embodiments, there is a piece of jewelry comprising: a connector to secure a first end of the piece of jewelry to a second end of the piece of jewelry; a plurality of stackable tool members; and an opening in at least one stackable tool member wherein the opening allows the at least one stackable tool member to be removed from the piece of jewelry while the piece of jewelry is affixed to a wearer.

In alternate embodiments, the piece of jewelry comprises a plurality of stackable tool members further comprising a bend having an angle of at least 10 degrees.

In yet another embodiment, the piece of jewelry comprises a plurality of stackable tool members which further comprises a bend having an angle of about 90 degrees.

In an additional embodiment, the piece of jewelry comprises at least one stackable tool member further comprising at least one tool on both ends of the at least one stackable tool member.

In yet another embodiment, the piece of jewelry comprises at least one stackable tool member further comprising at least one cutout for reducing the weight of the at least one stackable tool member.

In an alternative embodiment, the piece of jewelry of claim comprises a plurality of stackable tools further comprising a top clamping member proximal to a top side of the plurality of stackable tool members.

In a further embodiment, the piece of jewelry is a necklace, a bracelet, a headband, a belt, an ear-loop, a piercing, an arm-band, an anklet, or a collar.

In an additional embodiment, the piece of jewelry further comprises one or more stoppers.

In yet another embodiment, the piece of jewelry comprises at least one of the following tools: a wrench, an adjustable wrench, a hex wrench, an allen key, a Philips screwdriver, a flat head screw driver, a micro-tip screwdriver, a knife blade, a box cutter, a letter opener, a saw, scissors, a nail clipper, a flint, a fishing hook, a can opener, a wire stripper, a hammer head, pliers, a nail puller, a staple remover, a bottle opener, a wine cork opener, a SIM card ejector tool, a phone stand, a tablet stand, a ruler, a drill bit gauge, a file, or a fruit peeler.

In yet an additional embodiment, the piece of jewelry comprises a plurality of stackable tool members further comprising a bottom clamping member proximal to a bottom side of the plurality of stackable tool members.

In a further embodiment, the piece of jewelry comprises a top clamping member or a bottom clamping member which is not removable from the piece of jewelry while the jewelry is affixed to the wearer.

In an additional embodiment, the piece of jewelry comprises a top clamping member or a bottom clamping member that is stackable.

In an additional embodiment, the piece of jewelry comprises a top clamping member or a bottom clamping member further comprising an opening wherein the opening allows the top clamping member or the bottom clamping member to be removed from the piece of jewelry while the piece of jewelry is still affixed to the wearer.

In an alternate embodiment, the piece of jewelry comprises a top clamping member or a bottom clamping member further comprising at least one tool thereon.

In an additional embodiment, the piece of jewelry comprises a plurality of stackable tool members.

In yet another embodiment, the piece of jewelry has at least one tool member comprising a flat body, wherein the tool member: is attached to the piece of jewelry; and has a bend having an angle of about 90 degrees.

In a further embodiment, the piece of jewelry has at least one tool member comprising a flat body, wherein the at least one tool member: is attached to the piece of jewelry; and has a curvilinear bend ranging between about 90 degrees to about 180 degrees.

In an alternative embodiment, the piece of jewelry has at least one stackable tool member.

In an additional embodiment, the piece of jewelry further comprising an opening in the at least one stackable tool member wherein the opening allows the at least one stackable tool member to be removed from the piece of jewelry while the piece of jewelry is affixed to a wearer.

### BRIEF DESCRIPTION OF THE DRAWINGS

FIG. 1A is a front elevation view of a first embodiment of a multi-tool piece of jewelry disclosed herein;

FIG. 1B is a front perspective sectional view of a first embodiment of a multi-tool piece of jewelry disclosed herein;

FIG. 1C is a front sectioned view of a first embodiment of a multi-tool piece of jewelry disclosed herein;

FIG. 1D is a top sectioned view of a first embodiment of a multi-tool piece of jewelry disclosed herein;

FIG. 1E is a bottom sectioned view of a first embodiment of a multi-tool piece of jewelry disclosed herein;

FIG. 1F is a left side sectioned view of a first embodiment of a multi-tool piece of jewelry disclosed herein;

FIG. 1G is a right side sectioned view of a first embodiment of a multi-tool piece of jewelry disclosed herein;

FIG. 2A is a front elevation view of a second embodiment of a multi-tool piece of jewelry disclosed herein;

FIG. 2B is a front perspective sectional view of a second embodiment of a multi-tool piece of jewelry disclosed herein;

FIG. 2C is a front sectioned view of a first embodiment of a multi-tool piece of jewelry disclosed herein;

FIG. 2D is a top sectioned view of a first embodiment of a multi-tool piece of jewelry disclosed herein;

FIG. 2E is a bottom sectioned view of a first embodiment of a multi-tool piece of jewelry disclosed herein;

FIG. 2F is a left side sectioned view of a first embodiment of a multi-tool piece of jewelry disclosed herein;

FIG. 2G is a right side sectioned view of a first embodiment of a multi-tool piece of jewelry disclosed herein

FIG. 3A is a front elevation view of a stackable tool member found in embodiments of the multi-tool piece of jewelry disclosed herein;

FIG. 3B is a front perspective view of a stackable tool member found in embodiments of a multi-tool piece of jewelry disclosed herein;

FIG. 3C is a rear elevation view of a stackable tool member found in embodiments of a multi-tool piece of jewelry disclosed herein;

FIG. 3D is a top plan view of a stackable tool member found in embodiments of a multi-tool piece of jewelry disclosed herein;

FIG. 3E is a bottom plan view of a stackable tool member found in embodiments of a multi-tool piece of jewelry disclosed herein;

FIG. 3F is a right elevation view of a stackable tool member found in embodiments of a multi-tool piece of jewelry disclosed herein;

FIG. 3G is a left elevation view of a stackable tool member found in embodiments of a multi-tool piece of jewelry disclosed herein;

FIG. 4A is a front elevation view of an alternate stackable tool member found in embodiments of the multi-tool piece of jewelry disclosed herein;

FIG. 4B is a front perspective view of an alternate stackable tool member found in embodiments of a multi-tool piece of jewelry disclosed herein;

FIG. 4C is a rear elevation view of an alternate stackable tool member found in embodiments of a multi-tool piece of jewelry disclosed herein;

FIG. 4D is a top plan view of an alternate stackable tool member found in embodiments of a multi-tool piece of jewelry disclosed herein;

FIG. 4E is a bottom plan view of an alternate stackable tool member found in embodiments of a multi-tool piece of jewelry disclosed herein;

FIG. 4F is a right elevation view of an alternate stackable tool member found in embodiments of a multi-tool piece of jewelry disclosed herein;

FIG. 4G is a left elevation view of an alternate stackable tool member found in embodiments of a multi-tool piece of jewelry disclosed herein;

FIG. 5A is a front elevation view of a clamping member used in embodiments of the multi-tool piece of jewelry disclosed herein;

FIG. 5B is a front perspective view of a clamping member used in embodiments of a multi-tool piece of jewelry disclosed herein;

FIG. 5C is a rear elevation view of a clamping member used in embodiments of a multi-tool piece of jewelry disclosed herein;

FIG. 5D is a top plan view of a clamping member used found in embodiments of a multi-tool piece of jewelry disclosed herein, the bottom plan view being a mirror image thereof;

FIG. 5E is a left elevation view of a clamping member used in embodiments of a multi-tool piece of jewelry disclosed herein, the right elevation view being a mirror image thereof;

FIG. 6A is a front elevation view of a third embodiment of the multi-tool piece of jewelry disclosed herein;

FIG. 6B is a front perspective view of a third embodiment of a multi-tool piece of jewelry disclosed herein;

FIG. 7A is a front elevation view of a fourth embodiment of the multi-tool piece of jewelry disclosed herein;

FIG. 7B is a front perspective view of a fourth embodiment of a multi-tool piece of jewelry disclosed herein;

FIG. 8A is a front elevation view of a fifth embodiment of the multi-tool piece of jewelry disclosed herein;

FIG. 8B is a front perspective view of a fifth embodiment of a multi-tool piece of jewelry disclosed herein; and

FIG. 9 is a front perspective view of a stackable tool member found in embodiments of a multi-tool piece of jewelry disclosed herein.

### DETAILED DESCRIPTION

Those of skill in the art will recognize throughout this specification that when like terms are used to describe features and functionalities of various portions of a particular embodiment, those same features and functionalities could be present in additional embodiments having aspects with like terms.

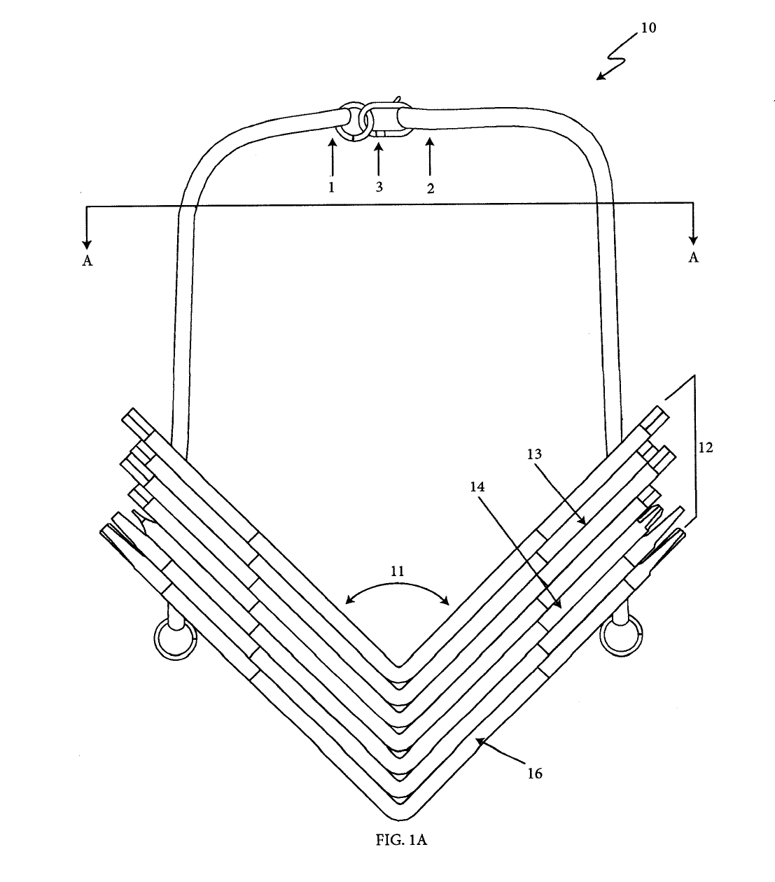

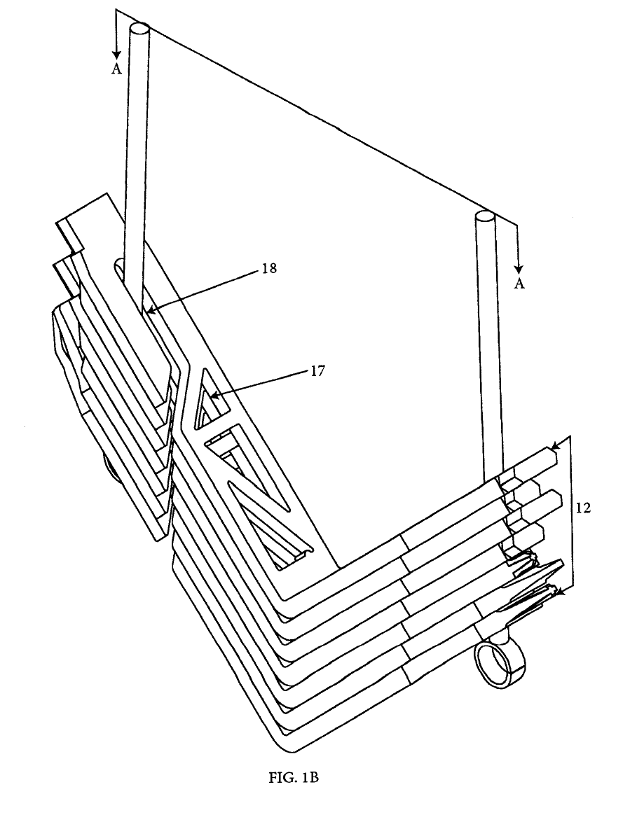

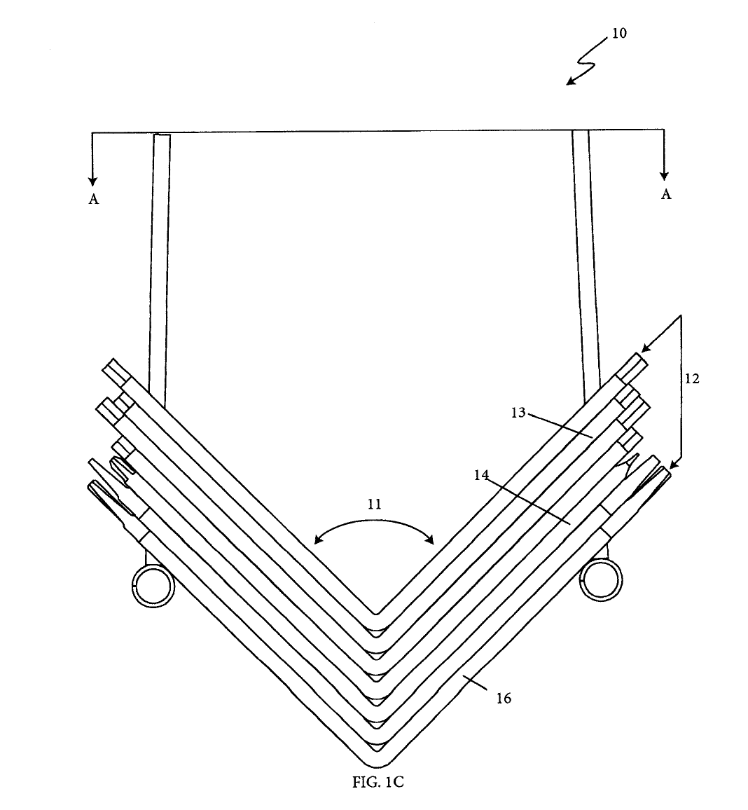

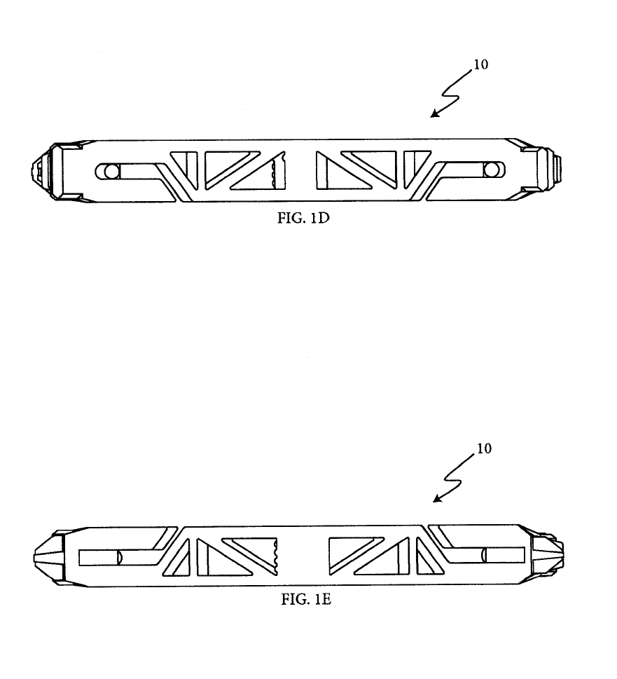

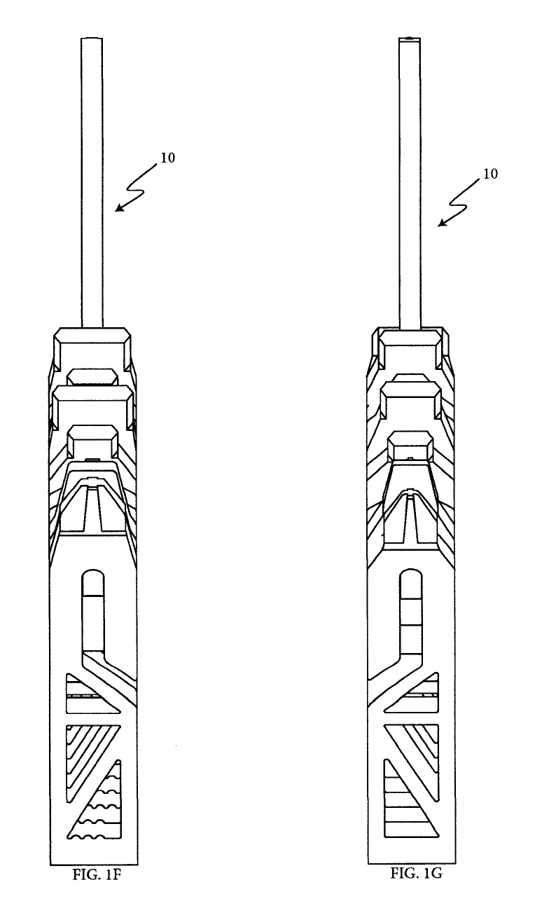

FIGS. 1A-1G depict a first embodiment of the multi-tool jewelry of the present invention. In this embodiment, there is shown a piece of jewelry 10 having a connector 2 for affixing the piece of jewelry 10 around a portion of a wearer. In this embodiment and other embodiments described throughout this specification, the piece of jewelry 10 could be a necklace, bracelet, headband, belt, ear-loop, piercing, arm-band, or anklet. In alternate embodiments, the piece of jewelry 10 could be a collar for dogs, cats, reptiles, and the like.

Referring to FIG. 1A, in this embodiment, the piece of jewelry 10 is a necklace having a connector 3 used to secure a first end 1 of a piece of jewelry to a second end 2 of a piece of jewelry. In this embodiment, the connector 3 is a spring ring clasp. In alternate embodiments, the connector 3 could be a lobster claw clasp, a barrel clasp, a toggle clasp, an S-clasp, a hook clasp, a magnetic clasp, a fishhook clap, a slide lock clasp, a latch clasp, a box clasp, a screw clasp, a button toggle clasp, a crimping clasp, a snap and button clasp, a loop, and the like.

The piece of jewelry 10 is further comprised of a plurality of stackable tool members 12. In this embodiment, we show seven total stackable tool members 12. In alternate embodiments, the number of stackable tool members 12 could be as few as one to as many as desired by the consumer wearing the piece of jewelry 10. One of the benefits of the embodiments of the present invention is the modular nature of the pieces of jewelry 10, 20, 30, 40, 50 disclosed herein in the sense that consumers can add or remove stackable took members 12 as desired. If for example, an individual owning one of the pieces of jewelry 10, 20, 30, 40, 50 desires to go on a mountain bike ride, she may want to include stackable tool members 12 that could be used to perform bike repairs if needed during her ride.

The plurality of stackable tool members 12 is comprised of individual stackable tool members, e.g., 13, 14, or 16. These individual stackable tool members 13, 14, or 16 can have a variety of tools on either end. Indeed, in alternate embodiments, tools can vary and include options such as a stackable tool member 13 having two hex wrenches, one on either end. In some embodiments, these hex wrenches could be the same size or different sizes. Stackable tool member 14 depicts an embodiment having two different tools on each end, that is a Phillips screw driver on one end and a flat head screw driver on the other end.

Stackable tool member 16 shows two different sizes of screwdriver on either end, namely a micro-tip screwdriver and a flathead screwdriver. In some embodiments, stackable tool member 16 could have a micro-tip, Phillips, or flathead screw driver on either of its ends depending on variations of sizing for the screwdrivers. In some embodiments, a flathead screwdriver or micro-tip screwdriver can be used with a Phillips head screw if the proportions of the screwdriver are such that they securely couple to the interior to the Phillips head screw.

In alternate embodiments, the tools on either end of any of the plurality of stackable tool members could be any one or more of the following: a wrench, an adjustable wrench, a hex wrench, an allen key, a Philips screwdriver, a flat head screw driver, a micro-tip screwdriver, a knife blade, a box cutter, a letter opener, a saw, scissors, a nail clipper, a flint, a fishing hook, a can opener, a wire stripper, a hammer head, pliers, a nail puller, a staple remover, a bottle opener, a wine cork opener, a SIM card ejector tool, a phone stand, a tablet stand, a ruler, a drill bit gauge, a file, or a fruit peeler. Those of skill in the art will recognize that any combination of these tools could be used without changing the spirit of the disclosed invention.

FIG. 1B depicts an opening 18 in the at least one stackable tool member wherein the opening allows an individual to remove a stackable tool member 13, 14, or 16 while the piece of jewelry 10 is affixed to a wearer. In one embodiment, the piece of jewelry 10 could be a necklace. The opening 18 is configured to allow a person wearing the necklace 10 to be able to remove any one or more of the plurality of stackable tool members 12 without having to take the necklace 10 off to use the tool(s) available in the plurality of stackable tool members 12.

The dimensions of the opening 18 are sufficient to enable the plurality of stackable tools members 12 to remain in place when they are being worn as part of the piece of jewelry. In embodiments, the width of the opening will be slightly larger than the diameter or width of the chain, rope, lanyard, cord, wire, cloth, yarn, poly-loop, and the like used to form the various pieces of jewelry 10, 20, 30, 50, 50. In this way, the plurality of stackable tool members will remain securely stacked one on top of another even when an individual or animal is moving around while wearing the piece of jewelry 10, 20, 30, 40, 50. The length of the opening 18 in some embodiments can range from 2 mm to 50 mm.

In certain embodiments, there can also be at least one cutout 17 for reducing the weight of the one or more of the plurality of stackable tool members 12. In some embodiments, there are numerous cutouts 17 in one or more of the plurality of stackable tool members 12. Although the cutouts 17 depicted in the various figures of the present invention are shown as being triangular, those of skill in the art will recognize that these cutouts 17 can be any of an infinite variety of geometric shapes.

The plurality of stackable tool members 12 can in some embodiments include a bend 11. In these embodiments, it is desirable for each of the individual stackable tool members 13, 14, 16 and the like, to have about the same bend angle so that the individual stackable tool members 13, 14, 16 and the like can rest in a fairly linear fashion one on top of the other when being worn by an individual or animal according to the present invention. In some embodiments, the bend 11 angle can be at least 10 degrees.

For clarity, a zero degree bend 11 angle would mean both ends of the individual stackable tool members 13, 14, 16 and the like were completely flat across, that is having no bend 11. A 180 degree bend 11 angle would mean both ends of the individual stackable tool members 13, 14, 16 and the like were fully bent such that they the left side and the right side of the individual stackable tool members 13, 14, 16 and the like were touching one another. In a preferred embodiment, the bend 11 angle could be about 90 degrees.

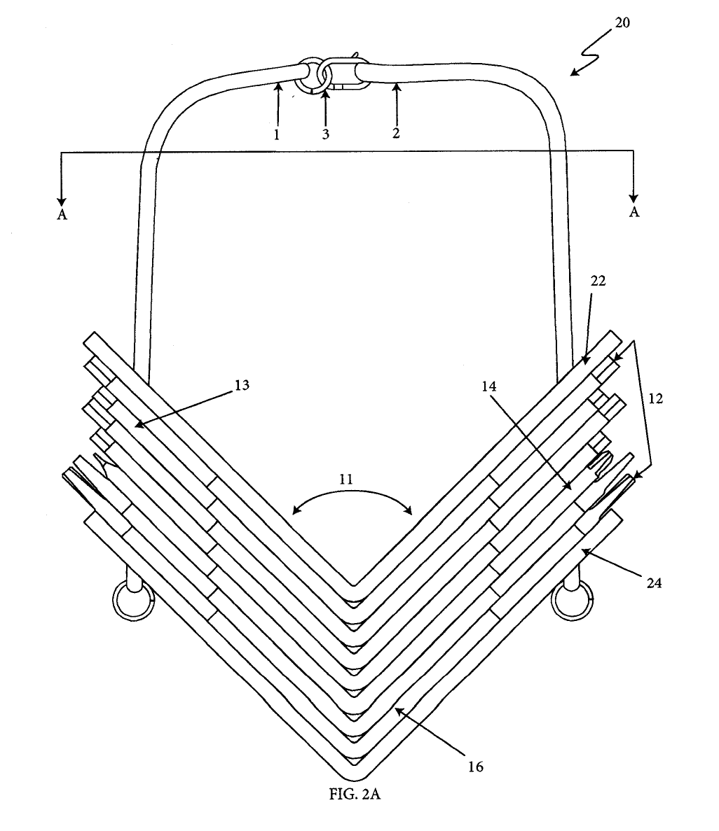

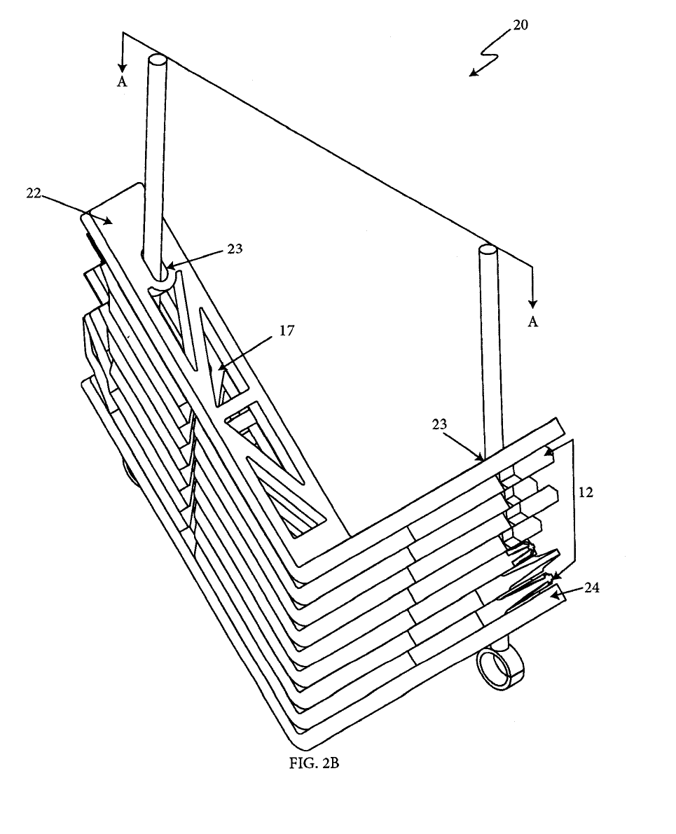

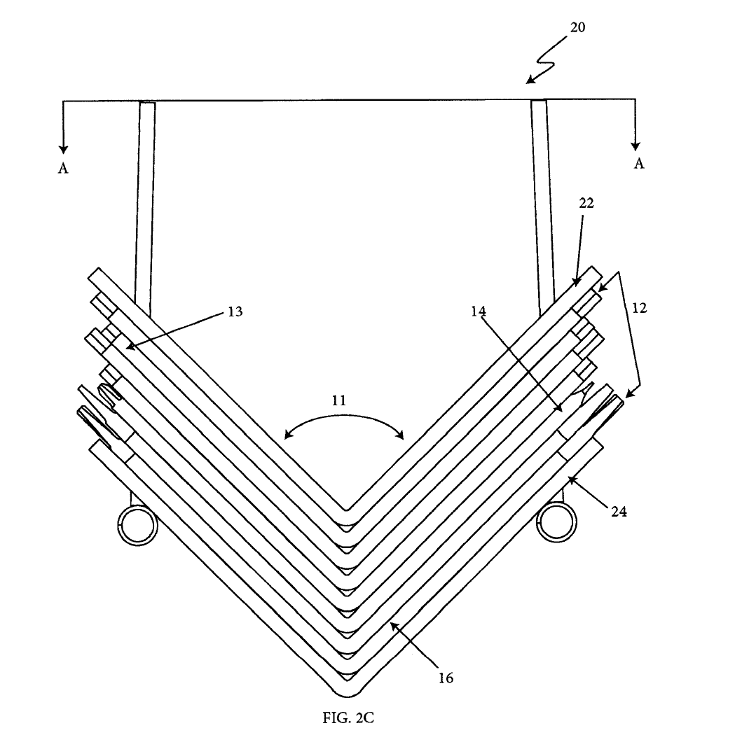

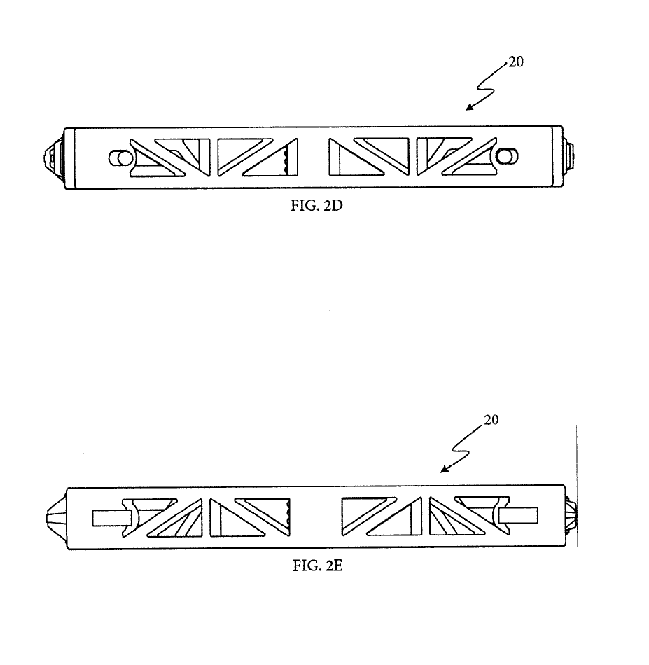

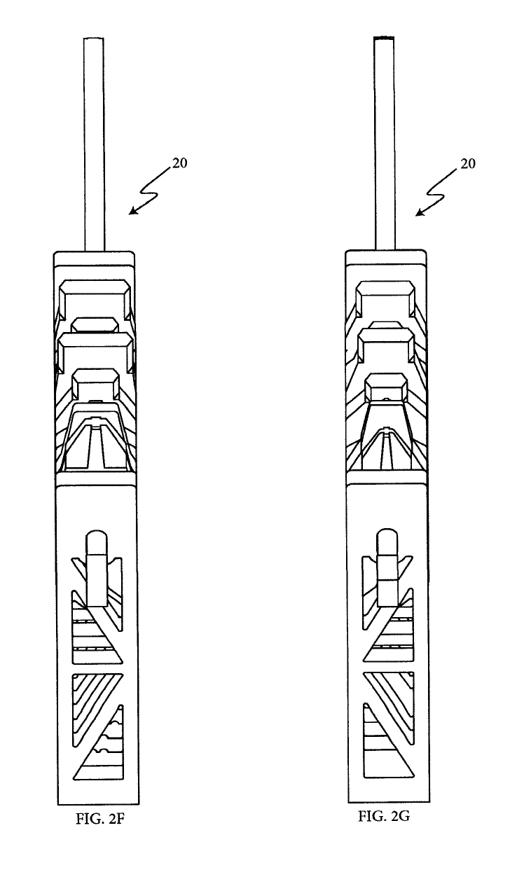

FIGS. 2A-2G depict an alternate embodiment of the piece of jewelry 20. The piece of jewelry 20 includes a first end 1, a second end 2, a connector 3, and a plurality of stackable tool members 12 having the features previously described with regard to embodiments of the piece of jewelry 10. Similarly, alternate embodiments of the piece of jewelry 20 can include a bend 11, a cutout 17, an opening 18, and individual stackable tool members 13, 14, or 16 having a wide array and combination of tools on one or both ends, as previously described.

The embodiments shown in the family of FIGS. 2A-2G depict an additional feature that helps secure the plurality of stackable tool members 12 on the piece of jewelry 20 so that none of the individual stackable tool members, e.g., 13, 14 or 16 inadvertently falls off of the wire, chain, or the like. In some instances, for example when an individual wearing the piece of jewelry 10 is engaged in excessive exercise, it is possible for one or more of the plurality stackable tool members 12 to accidentally become dislodged if, for example, the chain slips out of one or both openings 18 on one of more of the plurality of stackable tool members 12.

The embodiment of the piece of jewelry 20 prevents the inadvertent removal of one or more of the plurality of stackable tool members 12 by adding a top clamping member 22 proximal to a top side of the plurality of stackable tool members 12. In this embodiment, the top clamping member 22 has an enclosed hole 23 on either end through which the chain, wire, rope, or similar structural membrane of the piece of jewelry 22 passes. The enclosed hole 23 serves to ensure that the top clamping member 22 does not become dislodged from the piece of jewelry 20. In addition, the weight of the top clamping member 22 exerting a downward force on the plurality of stackable tool members 12 serves to hold each of the individual stackable tool members, e.g., 13, 14, or 16, in place so that none is accidentally dislodged during vigorous exercise or when removed and lying flat on a surface.

In an alternate embodiment, there could additionally be a bottom clamping member 24, which serves a similar purpose. When a user is wearing the piece of jewelry 20 of these embodiments, he or she could separate the top clamping member 22 or the bottom clamping member 24 from some or all of the plurality of stackable tool members 12 in order to remove one or more of the individual stackable tools, e.g., 13, 14, or 16. Once the compressive force of the clamping member 22 or 24 is removed, it will be easy for the individual to remove one or more of the individual stackable tool members, e.g., 13, 14, or 16, as previously described with reference to alternate embodiments. The top clamping member 22 and the bottom clamping member 24 are also aided by the geometry that the alignment of the openings 18 and enclosed hole 23 creates. The stackable tool members 12 have the opening 18 that is not aligned with the enclosed hole 23 of the top clamping member 22 or the bottom clamping member 24. This means that the top clamping member 22 or bottom clamping member 24 must be separated from the stackable tool members 12, in order to allow slack in the chain, or the like used to form the jewelry. It is only once this slack is provided, that the stackable tool members 12 can be removed. Since this slack is unlikely to occur without the intentional action of the user, this method provides for a reasonably secure method of keeping the stackable tool members 12 on the piece of jewelry until their use and removal is desired.

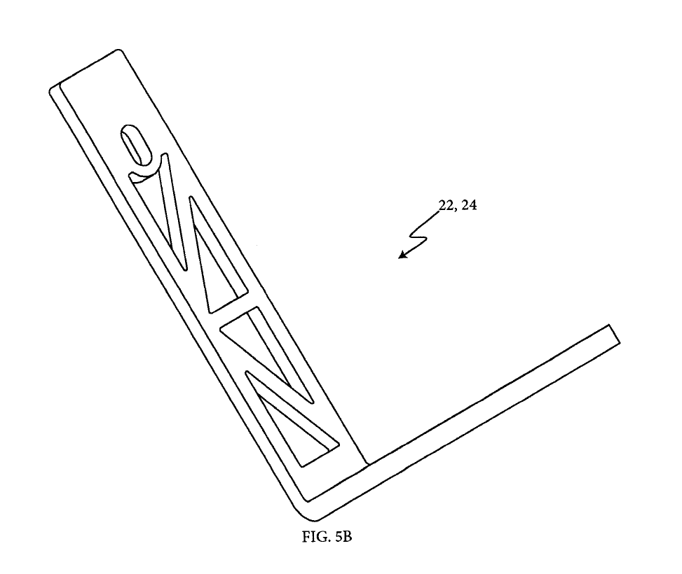

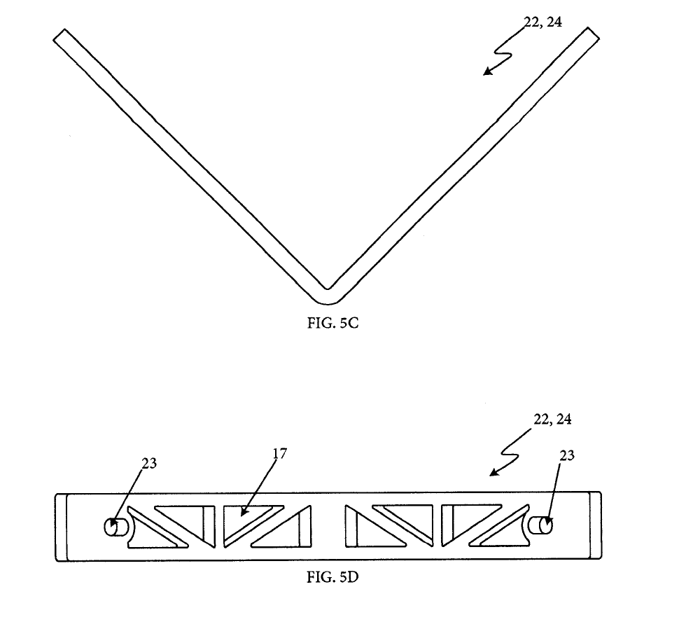

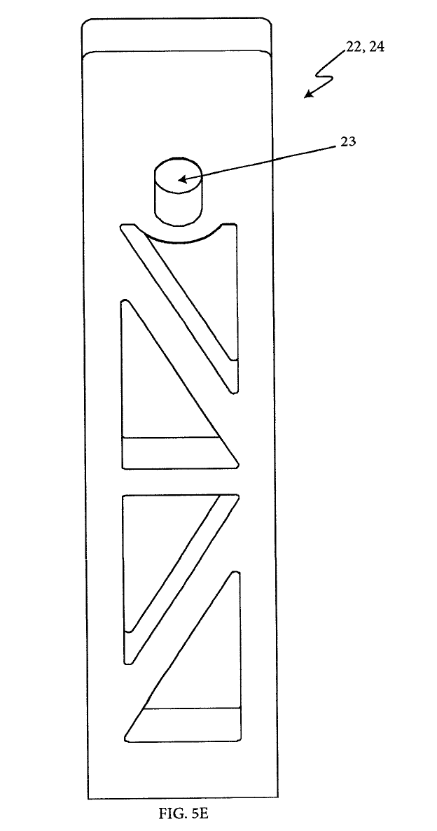

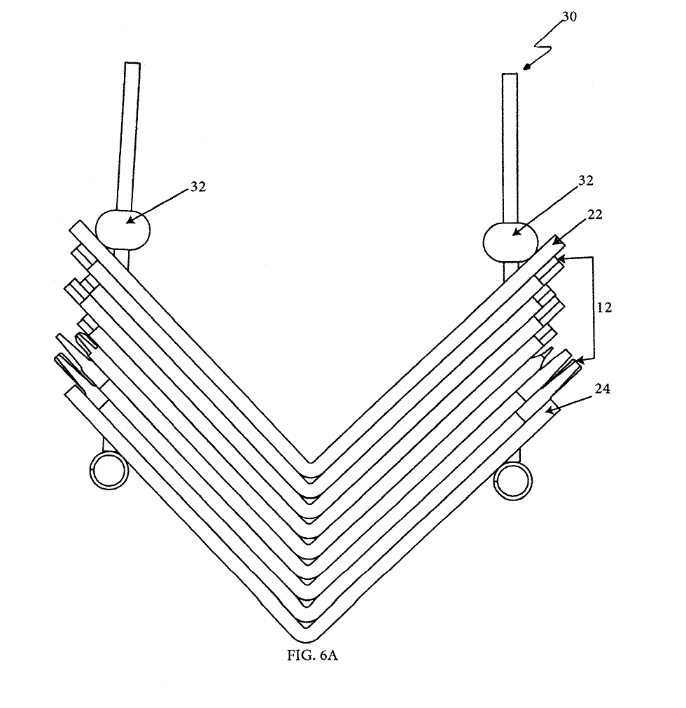

FIGS. 5A-5E show an embodiment of the top clamping member 22 and the bottom clamping member 24 separated from the piece of jewelry 20. As can be seen, the top clamping member 22 and the bottom clamping member 24 have an enclosed hole 23. In alternate embodiments, the top clamping member 22 or the bottom clamping member 24 could also have a bend 11 and one or more cutouts 17.

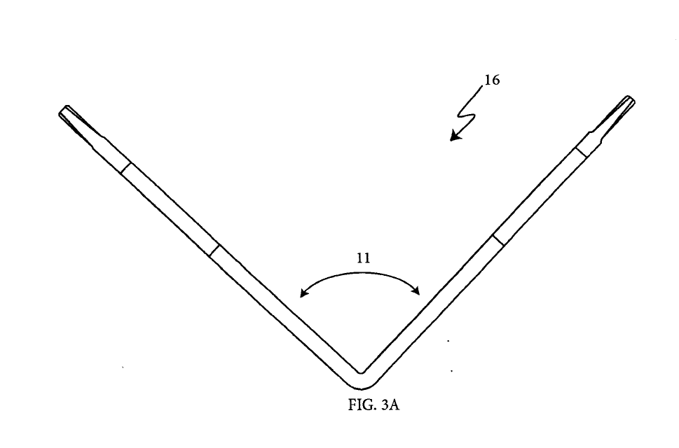

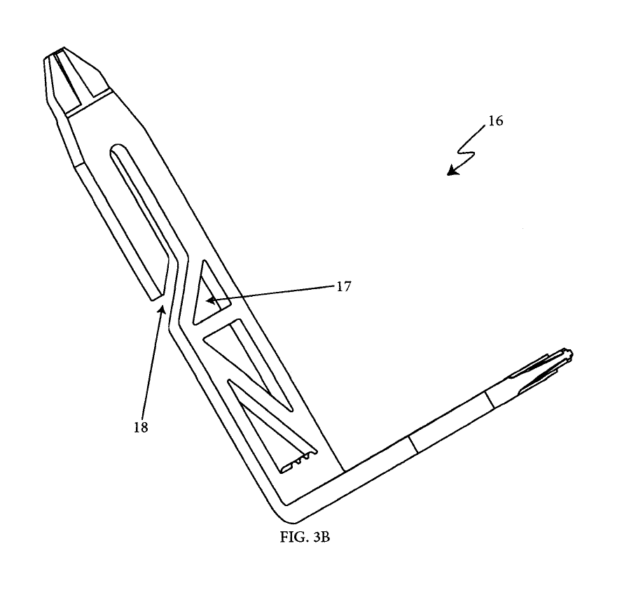

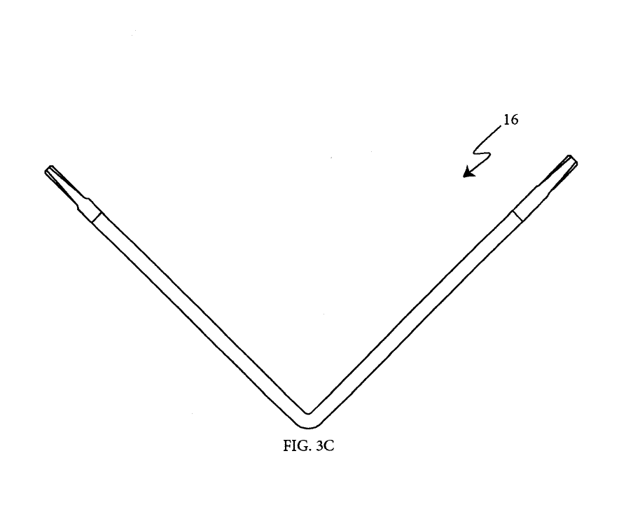

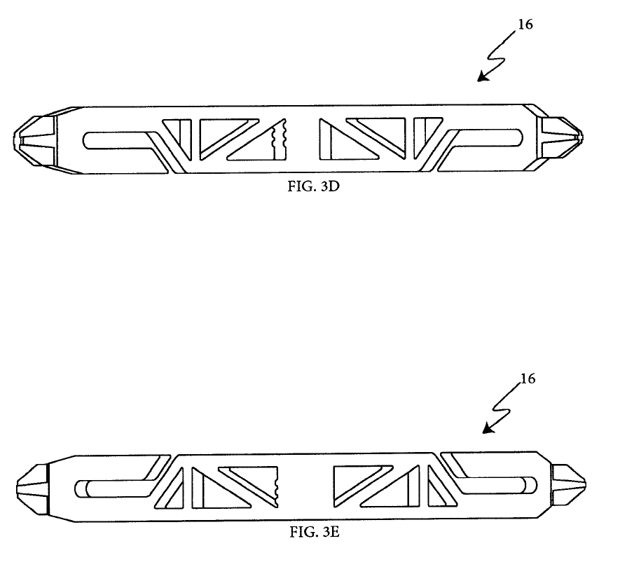

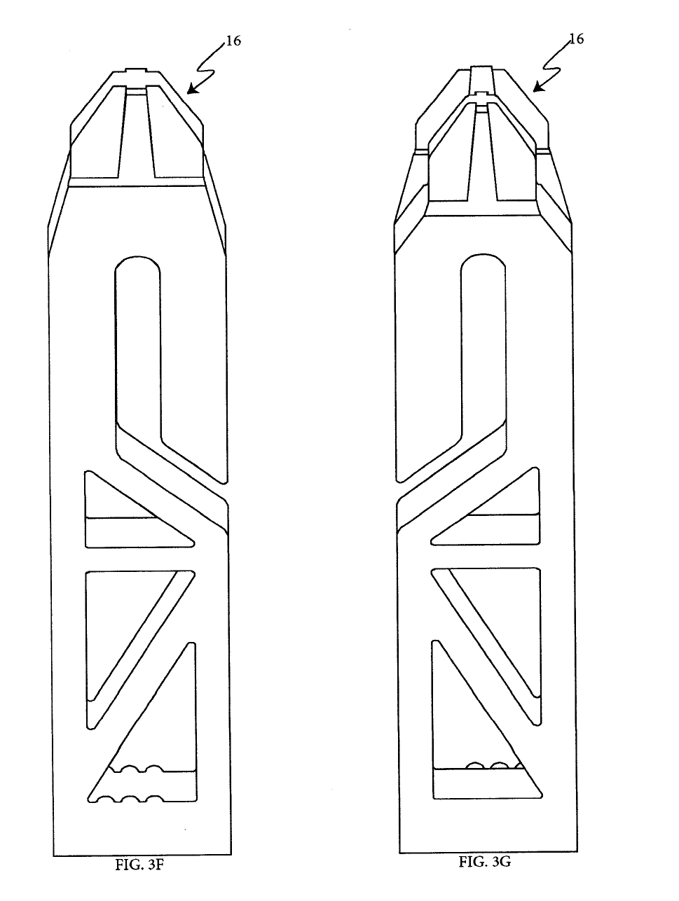

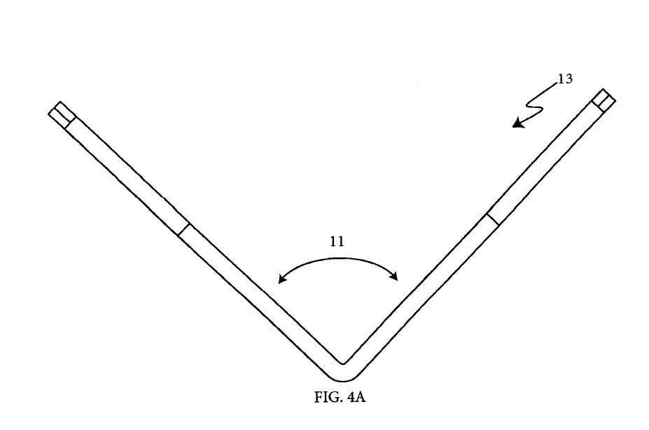

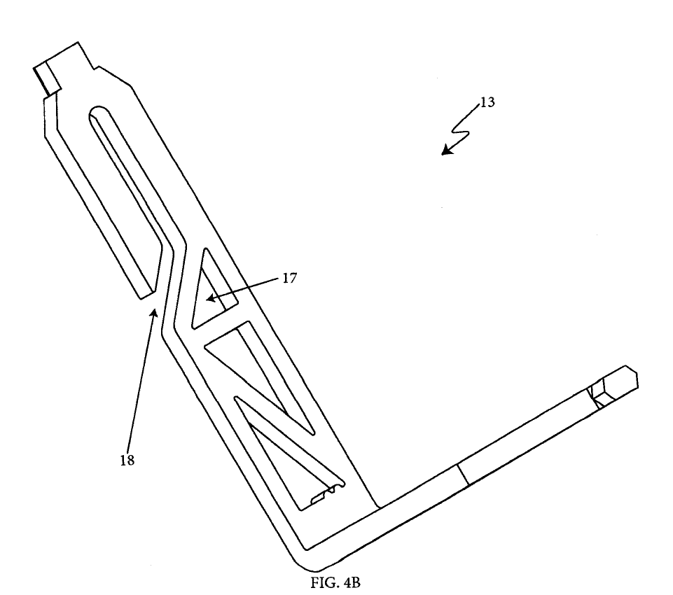

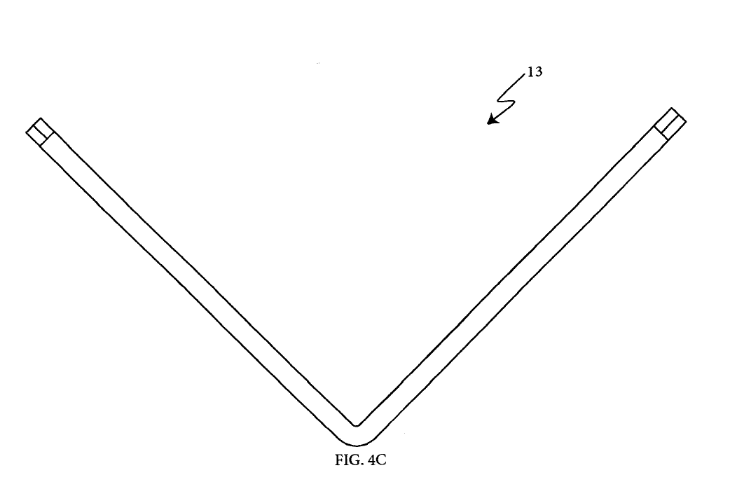

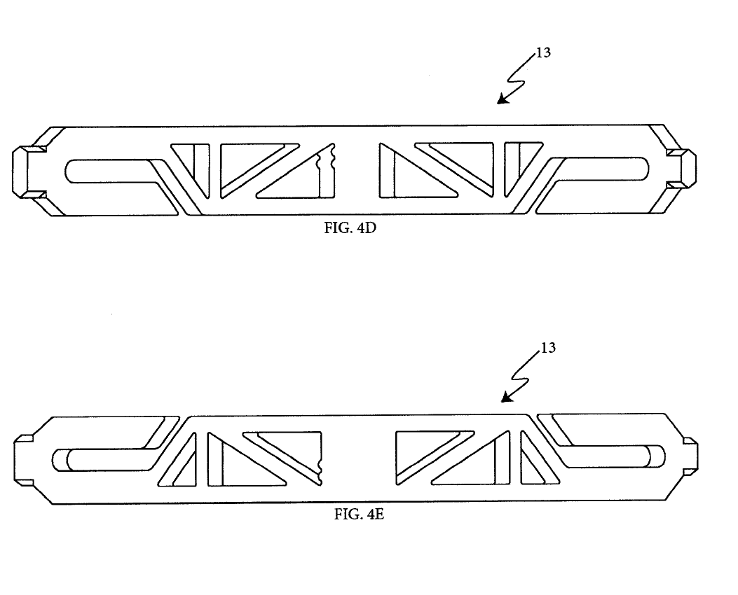

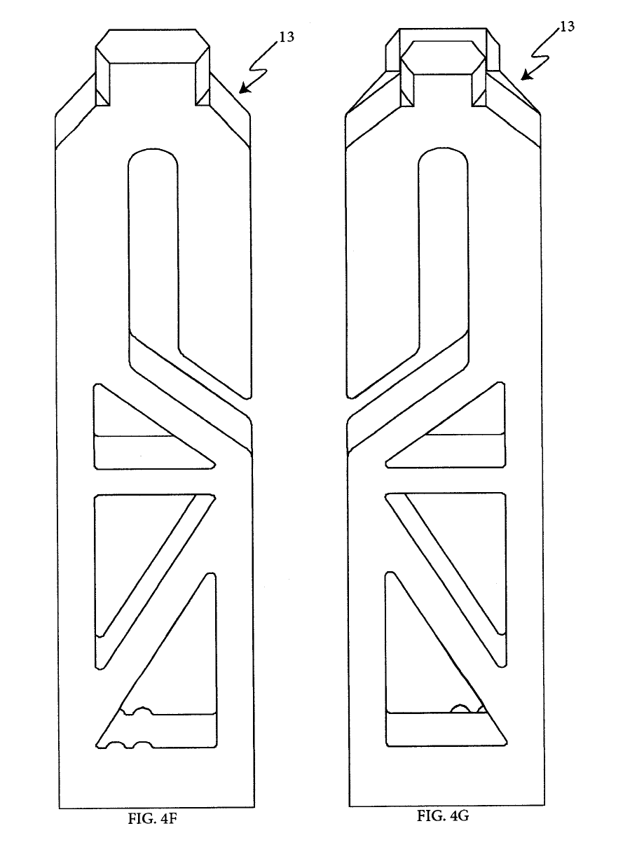

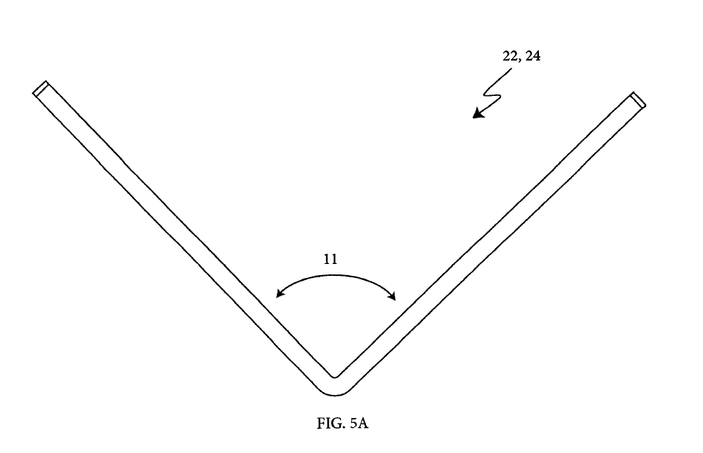

FIGS. 3A-3G depict an individual stackable tool member 16 having a screwdriver on either of its ends. Similarly, FIGS. 4A-4G depict an individual stackable tool member 13 having a hex wrench, or allen key, on either of its ends.

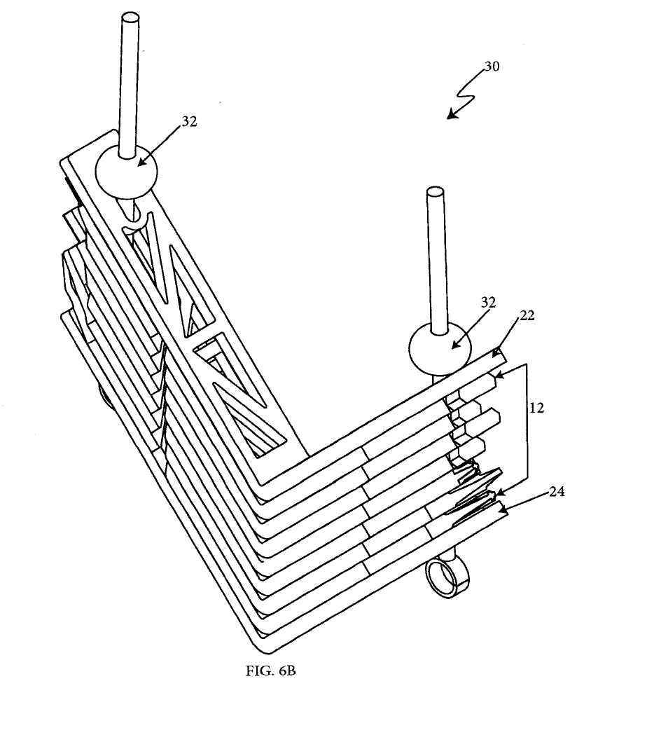

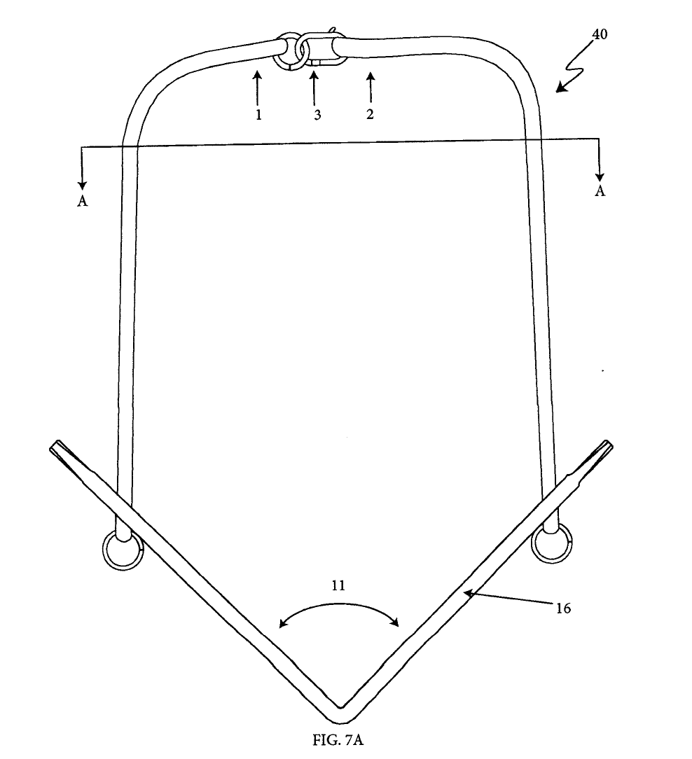

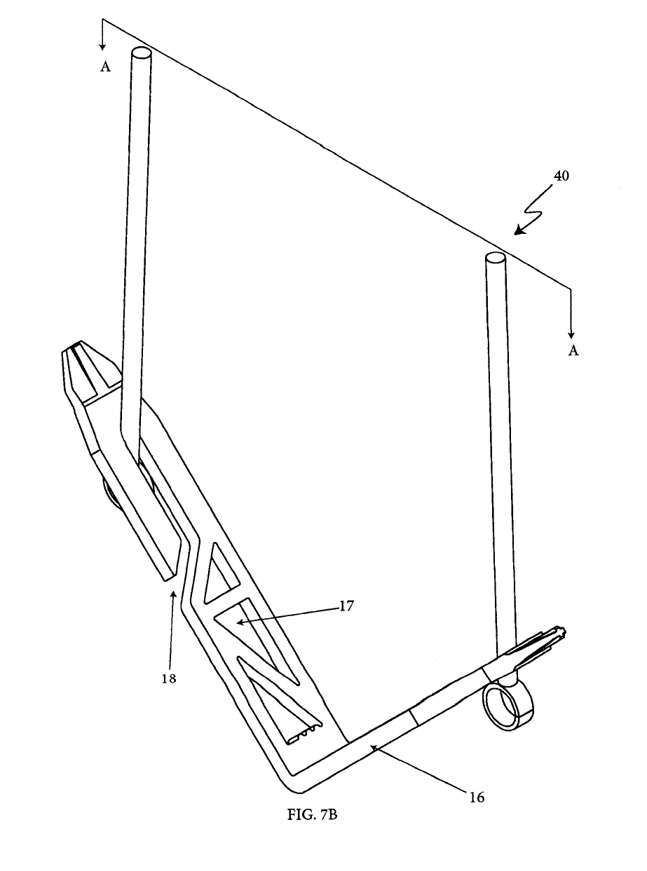

FIGS. 6A and 6B show an embodiment of the piece of jewelry 30 having one or more stoppers 32 proximal to a top clamping member 22. The top clamping member 22 is itself proximal to the plurality of stackable tool members 12. The stoppers 32 of this embodiment provide additional protection against one or more of the individual stackable tool members, e.g., 13, 14, or 16 from inadvertently fall off of the piece of jewelry 30. In an alternate embodiment, the one or more stoppers 32 could be proximal to the plurality of stackable tool members 12, if, for example, there was no top clamping member 22.

In an alternate embodiment, shown in FIGS. 7A and 7B, the piece of jewelry 40 is comprised of a first end 1, a second end 2 a connector 3, and a single stackable tool member 16. The single stackable tool member 16 can have the same attributes as described with respect to alternate embodiments. Specifically, the single stackable tool member 16 can include a bend 11, an opening 18, a cutout 17, one or more tools on either end, or a stopper 32.

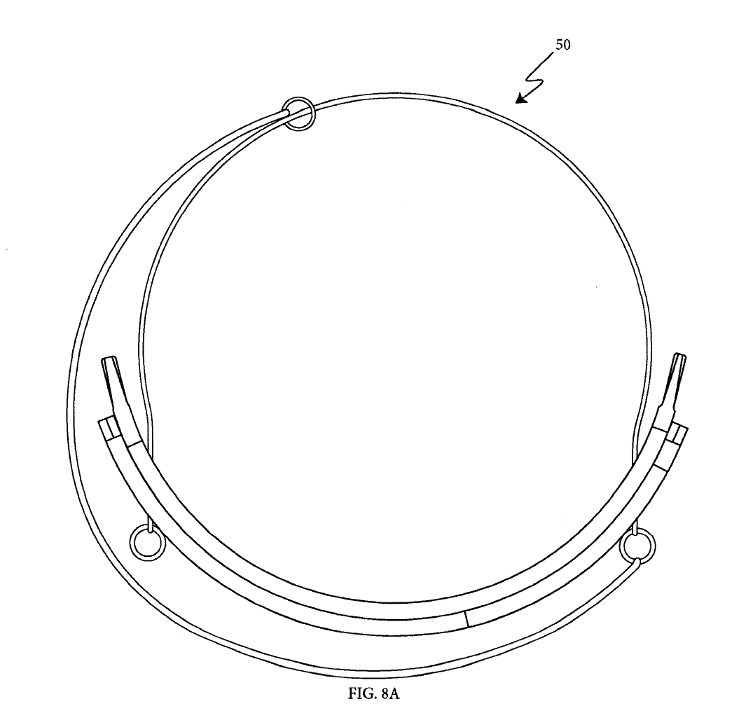

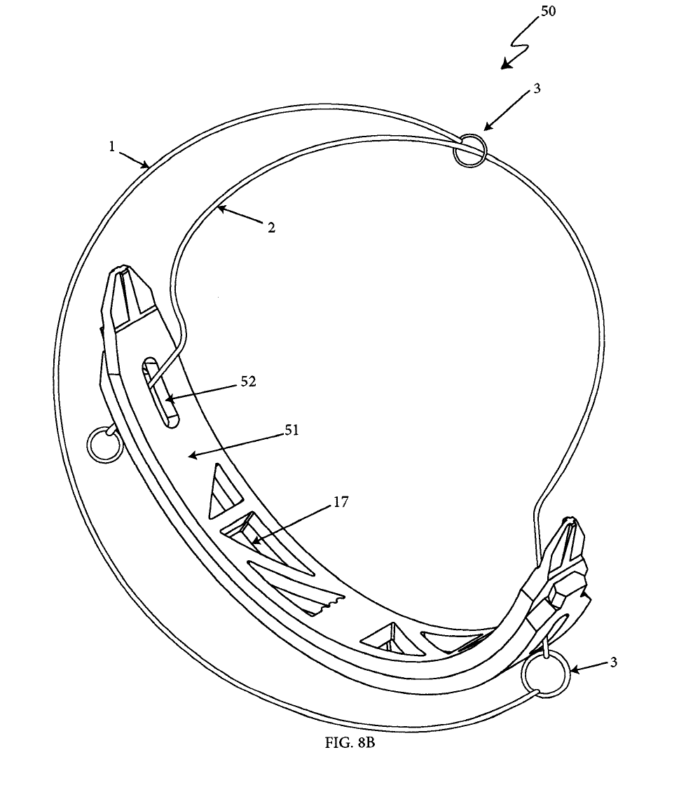

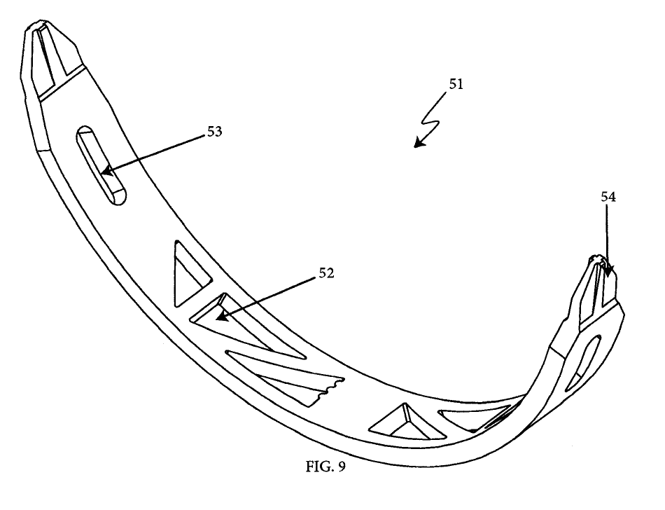

FIGS. 8A and 8B depict an alternate embodiment of the present invention wherein the piece of jewelry 50 is a bracelet having one or more stackable tool members 51. In this embodiment, the connector 3 could be a loop. Additionally, the first end 1 and the second end 2 of the piece of jewelry 50 could be fitted through a channel 53 having any geometric shape. In some embodiments, the channel 52 could be enclosed. And in alternate embodiments, the channel 53 could be an opening similar in function as previously described with respect to alternate embodiments having an opening 18.

FIG. 9 depicts a stackable tool member 51 having a channel 53, one or more cutouts 52, a tool 54 on one or more ends, and an arc angle of between 90 degrees and 180 degrees.

In certain embodiments, the pieces of jewelry 10, 20, 30, 40, 50 could range in height, as measured along the y-axis shown in FIG. 1A, from 0.25 inches to 5.0 inches. In additional embodiments, the pieces of jewelry 10, 20, 30, 40, 50 could range in length, as measured along the x-axis shown in FIG. 1A, from 0.5 inches to 8 inches. In yet other embodiments, the pieces of jewelry 10, 20, 30, 40, 50 could range in width, as measured along the z-axis shown in FIG. 1A, from 0.0625 inches to 1.5 inches.

In some embodiments, the pieces of jewelry 10, 20, 30, 40, 50 could be made of metal (for example and without limitation, stainless steel, ferromagnetic steel, other purpose steels, gold, silver, copper, titanium, aluminum, tungsten, or zinc), wood, plastic, silicone, plastic, ceramic, carbon fiber, or rubber. Some of these materials could in additional embodiments be subjected to treatment, such as hardening to further strengthen the tool body. For example, certain forms of both stainless and general purpose steel can be heat treated by heating the metal in a furnace to the critical temperature to change the molecular structure and then quenching to quickly cool the material and retain the modified molecular structure. In these embodiments, it is desirable to temper the metal at a lower temperature in a furnace shortly after quenching to restore a certain amount of toughness and reduce the brittleness of the material.

In alternate embodiments, the metal can be “cold” worked, such as cold rolling sheet metal, to impart internal stress into the bulk of the material, which acts similarly to heat treatment in modifying the physical properties of the material. Proper selection of material is important so that the key ring can be used for the intended functions without sustaining plastic deformation, as is the case when the applied stress exceeds the yield strength of the material. Hardening the metal, such as with the techniques described above, can help by increasing the yield strength of the material.

In one embodiment, the application of fine processes, such as laser cutting, could be used to create some or all of the stackable tool members. In alternate embodiments, the cutting tool could be an electrical discharge machining (EDM), electro-chemical erosion, water jet cutting, or similar techniques known to those skilled in the art. In an alternate embodiment, the stackable tool members could be created by using a blanking or even fine blanking stamping die to punch parts out of the sheet metal. In these embodiments, and others that are similar and known to those of skill in the art, the application of fine processes allows for precision edges, shapes, sizes, contours, and notches to be created thereby facilitating the operational and structural capabilities of the features discussed herein.

The articles “a” and “an” as used herein in the specification and in the claims, unless clearly indicated to the contrary, should be understood to include the plural referents. Claims or descriptions that include “or” between one or more members of a group are considered satisfied if one, more than one, or all of the group members are present in, employed in, or otherwise relevant to a given product or process unless indicated to the contrary or otherwise evident from the context.

The invention includes embodiments in which exactly one member of the group is present in, employed in, or otherwise relevant to a given product or process. The invention also includes embodiments in which more than one or the entire group of members is present in, employed in or otherwise relevant to a given product or process. Furthermore, it is to be understood that the invention encompasses all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise.

Where elements are presented as lists, (e.g., in Markush group or similar format) it is to be understood that each subgroup of the elements is also disclosed, and any element(s) can be removed from the group. It should be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in so many words herein. It should also be understood that any embodiment or aspect of the invention can be explicitly excluded from the claims, regardless of whether the specific exclusion is recited in the specification. The entire contents of all of the references (including literature references, issued patents and published patent applications and websites) cited throughout this application are hereby expressly incorporated by reference.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification, embodiments have been described in a way which enables a clear and concise specification to be written, but it is intended and will be appreciated, that embodiments may be variously combined or separated without departing from the invention. It is intended that the present invention be limited only to the extent required by the appended claims and the applicable rules of law.

What is claimed is:

1. A piece of jewelry comprising:
a. a connector to secure a first end of the piece of jewelry to a second end of the piece of jewelry;
b. a plurality of stackable tool members; and
c. an opening in at least one stackable tool member wherein the opening allows the at least one stackable tool member to be removed from the piece of jewelry while the piece of jewelry is affixed to a wearer.

2. The piece of jewelry of claim 1 wherein the plurality stackable tool members further comprise a bend having an angle of at least 10 degrees.

3. The piece of jewelry of claim 1 wherein the plurality of stackable tool members further comprises a bend having an angle of about 90 degrees.

4. The piece of jewelry of claim 1 wherein the at least one stackable tool member further comprises at least one tool on both ends of the at least one stackable tool member.

5. The piece of jewelry of claim 1 wherein the at least one stackable tool member further comprises at least one cutout for reducing the weight of the at least one stackable tool member.

6. The piece of jewelry of claim 1 wherein the plurality of stackable tools further comprises a top clamping member proximal to a top side of the plurality of stackable tool members.

7. The piece of jewelry of claim 1 wherein the piece of jewelry is a necklace, a bracelet, a headband, a belt, an ear-loop, a piercing, an arm-band, an anklet, or a collar.

8. The piece of jewelry of claim 1 further comprising one or more stoppers.

9. The piece of jewelry of claim 4 wherein the at least one tool comprises one or more of the following: a wrench, an adjustable wrench, a hex wrench, an allen key, a Philips screwdriver, a flat head screw driver, a micro-tip screwdriver, a knife blade, a box cutter, a letter opener, a saw, scissors, a nail clipper, a flint, a fishing hook, a can opener, a wire stripper, a hammer head, pliers, a nail puller, a staple remover, a bottle opener, a wine cork opener, a SIM card ejector tool, a phone stand, a tablet stand, a ruler, a drill bit gauge, a file, or a fruit peeler.

10. The piece of jewelry of claim 6 wherein the plurality of stackable tool members further comprises a bottom clamping member proximal to a bottom side of the plurality of stackable tool members.

11. The piece of jewelry of claim 10 wherein the top clamping member or the bottom clamping member is not removable from the piece of jewelry while the jewelry is affixed to the wearer.

12. The piece of jewelry of claim 10 wherein the top clamping member or the bottom clamping member is stackable.

13. The piece of jewelry of claim 10 wherein the top clamping member or the bottom clamping member further comprises an opening wherein the opening allows the top clamping member or the bottom clamping member to be removed from the piece of jewelry while the piece of jewelry is still affixed to the wearer.

14. The piece of jewelry of claim 13 wherein the top clamping member or the bottom clamping member further comprises at least one tool thereon.

15. A piece of jewelry comprising a plurality of stackable tool members.

16. The piece of jewelry of claim 15 wherein the piece of jewelry is a necklace, a bracelet, a headband, a belt, an ear-loop, a piercing, an arm-band, an anklet, or a collar.

17. A piece of jewelry having at least one tool member comprising a flat body, wherein the tool member:
a. is attached to the piece of jewelry; and
b. has a bend having an angle of about 90 degrees.

18. A piece of jewelry having at least one tool member comprising a flat body, wherein the at least one tool member:
a. is attached to the piece of jewelry; and
b. has a curvilinear bend ranging between about 90 degrees to about 180 degrees.

19. The piece of jewelry of claim 18 wherein the at least one tool member is stackable.

20. The piece of jewelry of claim 19 further comprising an opening in the at least one stackable tool member wherein the opening allows the at least one stackable tool member to be removed from the piece of jewelry while the piece of jewelry is affixed to a wearer.
